(19) United States
(12) Patent Application Publication
(10) Pub. No.: US 2026/0350117 A1
(43) Pub. Date: Nov. 5, 2026

(54) TEXT AND MEDIA ENCODERS FOR CLASSIFYING MEDIA, DETERMINING PROMPTS, AND UNCOVERING BIAS IN MACHINE LEARNING MODELS

(71) Applicant: Visa International Service Association, San Francisco, CA (US)

(72) Inventors: Junpeng Wang, Santa Clara, CA (US); Michael Yeh, Palo Alto, CA (US); Yujie Fan, Cleveland Heights, OH (US); Xin Dai, Fremont, CA (US); Yan Zheng, Los Gatos, CA (US); Liang Wang, San Jose, CA (US); Wei Zhang, Fremont, CA (US)

(73) Assignee: Visa International Service Association, San Francisco, CA (US)

(21) Appl. No.: 19/478,238

(22) PCT Filed: Apr. 25, 2024
(86) PCT No.: PCT/US2024/026311

§ 371 Date: Oct. 23, 2025

Related U.S. Application Data
(60) Provisional application No. 63/498,213, filed on Apr. 25, 2023.

(51) Int. Cl. G06F 18/24; G06N 5/04

(52) U.S. Cl. CPC G06F 18/24; G06N 5/04

(57) ABSTRACT

Embodiments are directed to methods and systems for media classification that may be used to better improve classification models and understand results of such classification. Various embodiments can determine a classification for a media item and can determine a prompt that includes the classification for a media item. Further embodiments can train a machine learning model using media items with known classifications. The results of each training iteration may be used to understand the result and improve the machine learning model.

### CROSS REFERENCE TO RELATED APPLICATIONS

This application is an international patent application which claims the benefit of the filing date of U.S. Patent Application No. 63/498,213 filed Apr. 25, 2023, which is herein incorporated by reference in its entirety for all purposes.

### BACKGROUND

A text template is known as a prompt, and prompt engineering is the effort of crafting prompts to improve the performance of different natural language processing models. However, there is little research in the space of prompt engineering in the context of large language models. Methods of identifying the best prompts are still missing. And improvements to machine learning image classification are needed.

Embodiments of the disclosure address these problems and other problems individually and collectively.

### SUMMARY

Embodiments are directed to methods and systems for media classification that may be used to better improve classification models and understand results of such classification. Various embodiments can determine a classification for a media item and can determine a prompt that includes the classification for a media item. Further embodiments can train a machine learning model using media items with known classifications. Understanding the results of each training iteration can improve the machine learning model.

Embodiments of the present disclosure can include a method; the method can include receiving a media item. The method can further include generating an encoded media item from media item where the encoded media item is in vector format. The method can also include inputting the encoded media item to a machine learning model, where the machine learning model is trained using media items having known classifications for corresponding encoded media items. Additionally, the method can include determining a classification for the media item.

Embodiments of the present disclosure may further include one or more of the following features. The method may further include generating a prompt using the encoded prompt output in vector format and generating a prompt using the encoded prompt output, the prompt describing features of the media item. The method may further include receiving a media item that is an image, an audio file, or a video.

Embodiments of the present disclosure may further include training the machine learning model by receiving training media, each of the training media having a known classification. The method may further include processing each of the training media to obtain training media encoding vectors and processing the media encoding vectors to obtain a predicted classification for each of the training media. The method may further include comparing the predicted classification to the known classification and updating parameters of the machine learning model based on the comparison.

Embodiments of the present disclosure may further include training the machine learning model by receiving a training text for each of the training, the training text including the known classification. The method may further include processing each training text to obtain training text ending vector. Processing the training media encoding vector to obtain the predicted classification may further include processing the training media encoding vectors and the training text encoding vectors to determine matching text-media pairs, where the training text of each of the text-media pairs includes the predicated classification of a corresponding training media item.

Embodiments of the present disclosure can include a method. The method can include receiving a media item. The method can further include generating an encoded media item from the media item, where the encoded media item is in a vector format within an encoded media space. The method can further include inputting the encoded media item into a machine learning model that is trained to select an encoded text vector corresponding to a correct classification of the media item. The method can further include determining an encoded prompt output, the encoded prompt output in vector format. Additionally, the metho can include generating a prompt using the encoded prompt output, the prompt describing features of the media item.

Embodiments of the present disclosure may further include training the text decoder. Training the text decoder can include receiving a training prompt and generating an encoded prompt from the training prompt, wherein the encoded prompt is in vector format. The method can further include processing the encoded prompt to obtain a predicted prompt. The method can further include comparing the predicted prompt to the training prompt and updating the parameters of the text decoder based on the comparison.

Embodiments of the present disclosure can further include determining a classification for the media item by retrieving one or more reference encoded prompt vectors, each corresponding to a known classification. The method can further include determining a mapped vector by mapping from the encoded media item to the known classification. The method may further include comparing the mapped vector to the one or more reference encoded prompt vectors corresponding to the known classification to identify a closest encoded prompt vector. The method can further include determining a classification based on the closest encoded prompt vector.

These and other embodiments are described in further detail below. For example, other embodiments are directed to systems, devices, and computer readable media associated with methods described herein. A better understanding of the nature and advantages of embodiments of the present disclosure may be gained with reference to the following detailed description and accompanying drawings.

### TERMS

Prior to discussing embodiments of the disclosure, some terms can be described in further detail.

“Classification” may refer to a process by which something (such as a data value, feature vector, etc.) is associated with a particular class of things. For example, an image can be classified as being an image of a dog.

The term “artificial intelligence model” or “machine learning model” can include a model that may be used to predict outcomes to achieve a pre-defined goal. A machine learning model may be developed using a learning process, in which training data is classified based on known or inferred patterns.

A “deep neural network (DNN)” may be a neural network in which there are multiple layers between an input and an output. Each layer of the deep neural network may represent a mathematical manipulation used to turn the input into the output. In particular, a “recurrent neural network (RNN)” may be a deep neural network in which data can move forward and backward between layers of the neural network.

“Machine learning” can include an artificial intelligence process in which software applications may be trained to make accurate predictions through learning. The predictions can be generated by applying input data to a predictive model formed from performing statistical analyses on aggregated data. A model can be trained using training data, such that the model may be used to make accurate predictions. The prediction can be, for example, a classification of an image (e.g., identifying images of cats on the Internet) or as another example, a recommendation (e.g., a movie that a user may like or a restaurant that a consumer might enjoy).

A “machine learning model” may include an application of artificial intelligence that provides systems with the ability to automatically learn and improve from experience without explicitly being programmed. A machine learning model may include a set of software routines and parameters that can predict an output of a process (e.g., identification of an attacker of a computer network, authentication of a computer, a suitable recommendation based on a user search query, etc.) based on feature vectors or other input data. A structure of the software routines (e.g., number of subroutines and the relation between them) and/or the values of the parameters can be determined in a training process, which can use actual results of the process that is being modeled, e.g., the identification of different classes of input data. Examples of machine learning models include support vector machines (SVM), models that classify data by establishing a gap or boundary between inputs of different classifications, as well as neural networks, collections of artificial “neurons” that perform functions by activating in response to inputs. A machine learning model can be trained using “training data” (e.g., to identify patterns in the training data) and then apply this training when it is used for its intended purpose. A machine learning model may be defined by “model parameters,” which can comprise numerical values that define how the machine learning model performs its function. Training a machine learning model can comprise an iterative process used to determine a set of model parameters that achieve the best performance for the model. Various number of training samples can be used, e.g., at least 10, 100, 1,000, 5,000, 10,000, 50,000 or 100,000 training samples. One example is an unsupervised learning model. Another example type of model is supervised learning that can be used with embodiments of the present disclosure. Example supervised learning models may include different approaches and algorithms including analytical learning, statistical models, artificial neural network, backpropagation, boosting (meta-algorithm), Bayesian statistics, case-based reasoning, decision tree learning, inductive logic programming, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), random forests, ensembles of classifiers, ordinal classification, data pre-processing, handling imbalanced datasets, statistical relational learning, or Proaftn, a multicriteria classification algorithm. The model may include linear regression, logistic regression, deep recurrent neural network (e.g., long short term memory, LSTM), hidden Markov model (HMM), linear discriminant analysis (LDA), k-means clustering, density-based spatial clustering of applications with noise (DBSCAN), random forest algorithm, support vector machine (SVM), or any model described herein. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

A “feature vector” may include a set of measurable properties (or “features”) that represent some object or entity. A feature vector can include collections of data represented digitally in an array or vector structure. A feature vector can also include collections of data that can be represented as a mathematical vector, on which vector operations such as the scalar product can be performed. A feature vector can be determined or generated from input data. A feature vector can be used as the input to a machine learning model, such that the machine learning model produces some output or classification. The construction of a feature vector can be accomplished in a variety of ways, based on the nature of the input data. For example, for a machine learning classifier that classifies words as correctly spelled or incorrectly spelled, a feature vector corresponding to a word such as “LOVE” could be represented as the vector (12, 15, 22, 5), corresponding to the alphabetical index of each letter in the input data word. For a more complex input, such as a human entity, an exemplary feature vector could include features such as the human's age, height, weight, a numerical representation of relative happiness, etc. Feature vectors can be represented and stored electronically in a feature store. Further, a feature vector can be normalized, i.e., be made to have unit magnitude. As an example, the feature vector (12, 15, 22, 5) corresponding to “LOVE” could be normalized to approximately (0.40, 0.51, 0.74, 0.17).

A “label” may be an output of a machine learning model. A label may be a numerical value, in particular a probability, or a classification. For example, labels may be fraud, non-fraud, spam, non-spam, dog, and cat. Labels may be output as a probability, such as 95% spam and 5% non-spam.

A “machine learning classifier” may include a machine learning model that can classify input data or feature vectors. For example, an image classifier is a machine learning model that can be used to classify images, such as images of animals. As another example, a news classifier is a machine learning model that can classify news articles as “real news” or “fake news.” As a third example, an anomaly detector, such as a credit card fraud detector, can classify input data such as credit card transactions as either normal or anomalous. The output produced by a machine learning classifier may be referred to as “classification data.” Machine learning classifiers may also include clustering models, such as K-means clustering. Clustering models can be used to partition input data or feature vectors into multiple clusters. Each cluster may correspond to a particular classification. For example, a clustering model may accept feature vectors corresponding to the size and weight of dogs, then generate clusters of feature vectors corresponding to small dogs, medium dogs, and large dogs. When new input data is included in a cluster (e.g., the small dogs cluster), the clustering model has effectively classified the new input data as input data corresponding to the cluster.

A “Prompt” is a piece of text injected into the text inputs of a Natural Language Processing (NLP) model. An NLP model uses the prompt as input.

### BRIEF DESCRIPTION OF THE DRAWINGS

FIG. 1A illustrates a system for pretraining a language-media machine learning model according to some embodiments.

FIG. 1B illustrates a language-media model 101 according to some embodiments of the present disclosure.

FIG. 2 illustrates a framework for determining the best prompt and interpreting the prompt according to some embodiments.

FIG. 3 illustrates a system for training a classification model according to some embodiments.

FIG. 4 illustrates a system for determining the classification of an image according to some embodiments.

FIG. 5 illustrates a system for determining the classification of according to some embodiments.

FIG. 6 illustrates a method of using a trained language-image machine learning model according to some embodiments.

FIG. 7 illustrates prompt decoding according to some embodiments.

FIG. 8 illustrates a method for determining the best prompt and then prompt decoding according to some embodiments.

FIG. 9 illustrates pseudo-code for generating a prompt landscape according to some embodiments.

FIG. 10 illustrates a principal component analysis projection of prompts and an example of a prompt landscape where a two dimensional space is extended, and each point is colored with the training loss.

FIG. 11 illustrates a random viewing angle of the prompt landscape.

FIG. 12 illustrates an example of decoded prompts obtained from decoding a prompt from the prompt landscape.

FIG. 13 illustrates a computer system that may be used with embodiments of the present disclosure.

### DETAILED DESCRIPTION

The accuracy of classifying images using a machine learning model could be increased. Images may be misclassified based on a bias of a machine learning model (e.g., co-occurrence). Some language-image machine learning models (e.g., zero-shot classification models, Contrastive Language Image Pretraining (CLIP), Bootstrapping Language-Image Pretraining (BLIP)) can use text labels of images during training. Prompts, which are pieces of text injected into the inputs of natural language processing (NLP) models, can significantly enhance the models' performance. Despite their effectiveness, a straightforward method for exploring a large number of possible prompts and assessing their quality in down-stream tasks (i.e., tasks that come after a pretraining phase) is lacking.

Existing language-image models that have been pre-trained on a large number of image-text pairs, performance of, for example, zero-shot image classification can be improved with the use of text labels. Prompts further refine text labels and even further improve classification performance. Nevertheless, current solutions often determine the best prompts through trial-and-error and, therefore, lack the ability to identify the best prompts for various datasets (e.g., a first image dataset, a second image data set, a first audio dataset).

To solve these problems, embodiments of the present disclosure allow for a large number of possible prompts to be presented as points on a 3D space to guide their exploration and enables users to decode any points of the 3D surface back into text for better interpretation. Thus, embodiments of the present disclosure allow for the best prompts to be identified for image classification tasks and for the interpretation of the identified prompts to disclose the essential features of image datasets. In this way, the accuracy of image classification models may be increased by finding the best prompts, visualizing the prompt landscape, and/or interpreting the best prompts to disclose the essential features of image data sets. Embodiments can also be used for other media besides images, e.g., for audio and video.

### I. Generation of Language-Media Model

As defined above, a prompt is a piece of text (i.e., text template) injected into the text inputs of a Natural Language Processing (NLP) model. The use of prompts in image recognition can significantly enhance the performance of such NLP models. Embodiments of the present disclosure explores the possible prompts and assess their quality, along with their use in creating encoded spaces that can be used to improve media classification, e.g., for images, audio, or video.

A language-media machine learning model, such as CLIP, may be trained on a large number of image-text pairs. Such a model may then perform zero-shot image classification, where the model may recognize new classes. The performance of such a model may be improved by text labels and prompts. A text label can include a class label specifying a classification of a media item.

### A. Architecture of Language-Media Model

Language-media models can be neural networks of various architectures, such as a large transformer model. Using a transformer model, for example, the model may consist of an encoder and decoder. The encoder may read and process input data into a continuous representation that holds all the learned insights from the input. The decoder may take the output of the encoder and generate an output sequence. The transformer model may be large in that it can include many layers, e.g., at least 3, 4, 5, 6, 7, 8, 9, 10, 11, 12, 13, 14, 15, or more. Each layer can include many attention heads resulting in a large number of model parameters (e.g., at least one million, two million, 10 million, 100 million, 1 billion, or billions of parameters).

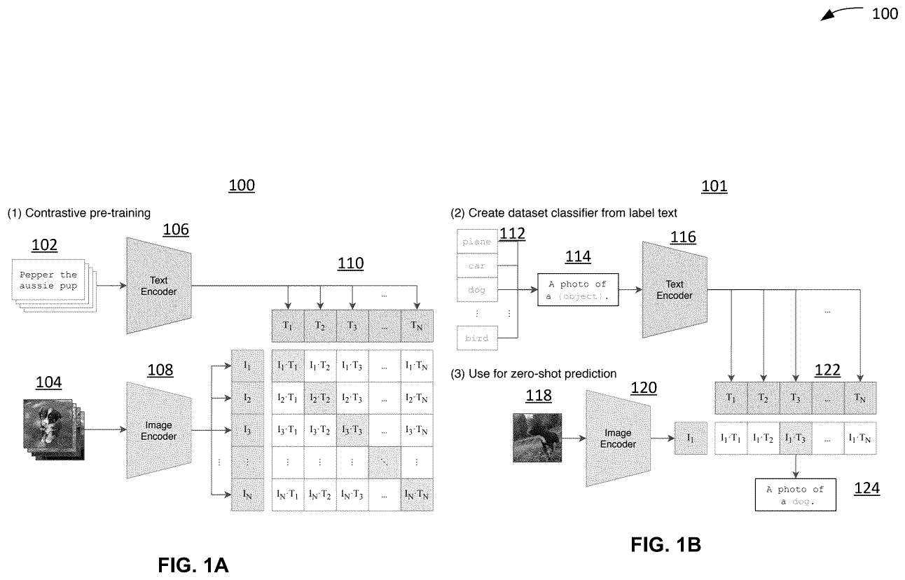

FIG. 1A illustrates a system 100 for training a language-media machine learning model according to some embodiments. In some embodiments, the language-media machine learning model may be a language-image machine learning model that may learn the association between images and texts (i.e., image caption) through contrastive learning. Such a model may contain text encoder 106 and image encoder 108, that encode texts and images into a high-dimensional (HD) space. For example, prompt 102 can be fed into text encoder 106, which then encodes the prompt into an encoded prompt (text) space. Similarly, image 104 can be fed into image encoder 108, which then encodes the image into an encoded image space. The prompt can be text that describes the image. Example sizes of the HD space are 258, 512, 1024, or 2048.

In this space, the training objective is to maximize the similarity between an image (Iᵢ) and its corresponding text description (Tᵢ), while minimizing the image's similarity to other texts. As illustrated in FIG. 1, this is implemented by maximizing the value of diagonal cells in matrix 110. That is, the dot product between the embeddings of an image-text pair, Iᵢ*Tᵢ, is maximized, while minimizing the values of non-diagonal cells, (Iᵢ·Tj, i≠j). The model may be trained with a large number of image-text pairs, e.g., at least 1,000, 5,000, 10,000, 50,000, and 100,000 image-text pairs. Parameters of the encoders are updated via an optimization technique to reduce a cost function or loss function that maximizes the diagonal cells and minimizes the non-diagonal cells.

The language-media model may be used for different downstream tasks, such as zero-shot image classification. In zero-shot classification, the model may learn to classify data that a model has not seen before. During training, the model learns from known categories and learns the characteristics of each category. The model may learn from descriptions or attributes of the categories. For example, if the model is trained on images, in can learn that cars have “wheels,” “doors,” and “windows.” The model then predicts the classification of new data based on matching attributes it has learned.

Given an image and its associated label, an m-class classification may be done, wherein the model must choose a category from more than two possible categories. Using text encoder 106 of the language-image learning model, each of the class labels, (i.e., classifications) may be encoded resulting in m embedding vectors (T₁, T₂ . . . . Tₘ). The image to be classified may be fed into image encoder 108 to generate an image embedding, I. The image embedding, I, may then be compared against the m text embeddings using dot product. The embeddings with the greatest dot product will be the predicted class of the image.

The classification performance may be further improved by crafting text labels, i.e., prompt engineering. For example, instead of feeding the label “dog” into a text encoder, feeding ‘a photo of a dog’ into the encoder for a better embedding. The prompt in this case is “a photo of a { },” where one can plug the m class labels into “{ }” to generate the m text embeddings for zero-shot classification. Systems and methods for exploring the space of prompts are needed for a greater understanding of the quality of different prompts and the ability to interpret the prompts.

### B. Training the Language-Media Model

As mentioned above, language-image model pretraining involved training the model to learn the correspondence between texts and images. For example, the CLIP model can use two transformer models to encode texts and images and learn their correspondence in the encoded space through contrastive loss. In another example, the bootstrapping language-image pretraining (BLIP) model further bootstraps the learning of knowledge between texts and images. These large pretrained language-image models can be used to serve many downstream tasks, such as visual question answering, image captioning, and classification.

Turning back to FIG. 1, training a language-image model utilizes text encoder 106 and image encoder 108 that encode texts and images into a high-dimensional (HD) space. Both text encoder 106 and image encoder 108 work similarly. Image encoder 108 may receive an image from a series of images 104, for example, a picture of a dog. Image encoder 108 can generate a vector Iᵢ for each image. Similarly, text encoder 106 may receive a series of prompts 102, for example, “Pepper the Aussie pup.” Text encoder 106 can generate a vector Tᵢ for each image. Once, the model is trained, there are image-text pairs where a text, or sentence, is describing the contents of the image.

Matrix 110 is created by the image-language model and has indexes for Tᵢ and Iᵢ, the location of the text and image pair, respectively. During training, both the text and image pair are known. As mentioned, matrix 110 is trained with the goal of maximizing the diagonal cells representing the matching pairs. The diagonal cells are computed using the dot product of the two embeddings, Tᵢ and Iᵢ. In this manner, the model is re-learning the correspondence between the image-text pairs.

FIG. 1B illustrates a language-media model 101 according to some embodiments of the present disclosure. Language-media model 101 may include text encoder 116 and image encoder 120. After language-media model 101 has been trained as discussed above in reference to FIG. 1A, language-media model 101 may, for example, closely associate a prompt 114 which includes classification 112 of a dog with pixels in a corresponding image of a dog. Language-media model 101 may be pretrained by OpenAI such as CLIP, which was trained by Open AI using about 400 million datasets. Once language-media model 101 is well trained, it may be capable of zero-shot learning. Language image model 101 can receive a list of classifications 112 that are input into text encoder 116. Language model 101 can also receive a prompt 114 that includes the classifications 112 that are input into text encoder 116.

In an example, language-media model 101 may be used for media classification, such as image classification. Image 118 may be input to image encoder 120. The possible classifications 112 may be known and be a limited set such as {plane, car, dog, bird}. The classifications 112 (not including additional prompt language) may be inserted into the text encoder 116. The first word will be stored at T₁, the second word at T₂, and so on. Assuming ten possible classifications, the model will create ten corresponding vectors 122. Similarly, the images inserted will be stored in order I₁, I₂, and so on. Then a dot product can be determined between each image and each of the vectors 122, e.g., I₁·Tᵢ, to find the maximum dot product value. The maximum dot product value may correspond to the closest image-text pair 124.

To improve results, one can input, into text encoder 116, a classification 112 surrounded by a sentence template, e.g., prompt 114. Text encoder 116 may then encode the prompt 114 which includes the corresponding classification 112, e.g., dog.

Using prompts significantly increases the accuracy of zero-shot classification in such pretrained models. Typical use of Residual Networks (ResNets) for image classification, which is CNN-based, results in 76.2% accuracy. The use of a language-image model utilizing prompts and the same datasets, results initially in roughly the same degree of accuracy. However, once the images start to vary from the original dataset, the accuracy of ResNet decreases and the language image model accuracy remains very high. What this shows is that ResNet struggles with image classification when the context of the image varies. For example, if an image of a banana is in black and white, is a drawing, or is made out of Legos, etc., ResNet's accuracy in classifying the images decreases. However, using a pretrained language-image model that utilizes prompts allows for the model to consider the semantics of text and its correlation to image pixels.

While the use of prompts increases accuracy in language-image classification, one can imagine an infinite number of potential prompts. Further research has shown that using eight hundred random prompts is not more effective than considering only a handful of good prompts. Where research lacks in this area is the identification of the best prompts to increase the accuracy of such classification models even further. Currently, there has been brute force attempts to identify better-performing prompts. However, there is a need in the art for systems and methods for determining the best prompts. Furthermore, there is a need to know the best possible prompts and be able to interpret the prompt and its context.

The Prompt Landscape is intended to provide a space to present prompts and identify which are good or bad. Such a visual presentation may also be helpful in selecting the best prompt for downstream classification tasks.

### II. Overview

In a Contrastive Language Image Pretraining (CLIP) model that includes a text-based model and image-based model, a template sentence (prompt) is input to the text-based model, where the prompt includes a placeholder for the classification. The image-based and text-based models each output vectors in an embedding space. By crafting text input into a prompt, the performance of a text-based model (e.g., NLP model, CLIP model) can be improved. For example, instead of feeding the class name “dog” into a text encoder, feeding a prompt of “a photo of a dog” into a text encoder may generate a better embedding. Thus, as an example, the prompt would be “a photo of <classification>.” Prompts may take an unlimited number of forms.

### A. Framework for Classification and Determining Prompt/Description of Media.

A prompt landscape may be implemented in three steps. First, a pre-trained language-media model (e.g., CLIP) may be used to encode images and text to a high dimensional space. Second, a linear model may be trained to the best prompt in the texts' embedding space and therefore, the classification of an image. Third, the identified best prompt is a high-dimensional vector, which can then be input into a text decoder (e.g., GPT-based text decoder) which may be trained to decode the high-dimensional vector back to the text space (i.e., a prompt). The text captures the essential features of the image data and can be used to better understand the data.

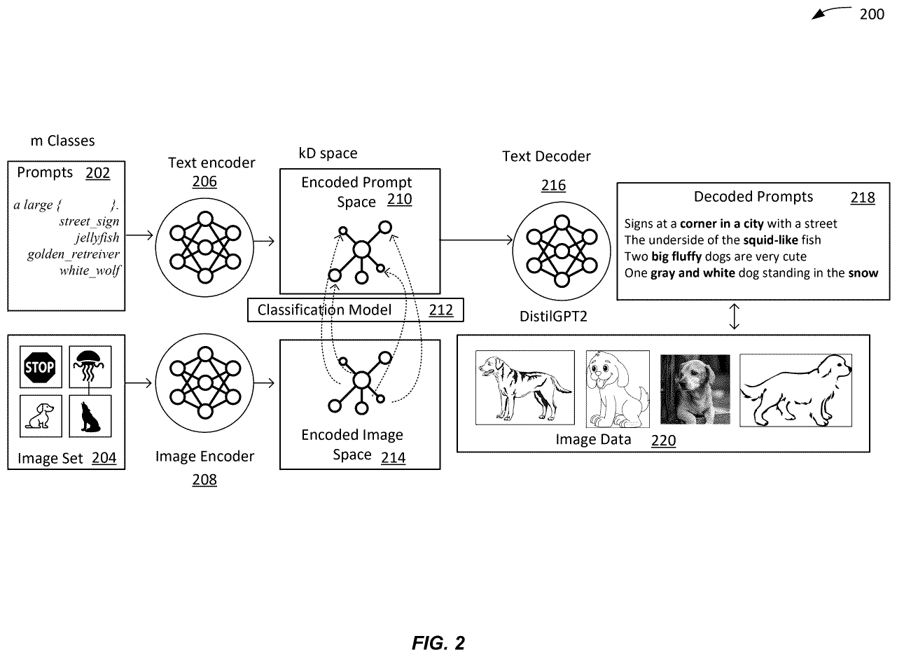

FIG. 2 illustrates a framework 200 for determining the best prompt and interpreting the prompt according to some embodiments. Framework 200 uses a pre-trained language image model (e.g., CLIP) to visually explore the space of prompts. Specifically, CLIP learns the associations between images and text through contrastive learning. The model contains a text encoder 206 and an image encoder 208.

System 200 is a framework to efficiently explore the space of prompts, reveal the prompts' quality, and interpret them. This may be done by considering the space composed of the embeddings of all possible prompts in the encoded prompt space 210. In this space, the pre-trained language-image model embeddings reside. Similarly, the space for the embeddings of images is the encoded image space 214. Finding the best prompt for an image dataset is equivalent to finding a point in the encoded prompt space 210, through which the embeddings of images from image set 204 get closer to the true labels' embedding. This finding can be implemented using a trained classification model 212. Classification model 212 can, for example, be implemented using stochastic gradient descent (SGD).

Text encoder 206 and image encoder 208 and encode respective text and images into a high-dimensional (HD) space (e.g., encoded image space 214 and encoded prompt space 210). The two encoders may extract relevant features from the text and image and represent them as vectors in a k-dimensional space. Thus, the encoder outputs a vector of length k. In the k-dimensional space, the objective is to maximize the similarity between an image and its corresponding text description while minimizing the similarity to the rest of the text descriptions that do not correspond to the image. Such a max-min may occur as a result of maximizing a dot product between the encoding of an image-text pair (e.g., pair of an encoded text/prompt within the encoded prompt space 210 and corresponding encoded image from the image set 204 within the encoded image space 214) while minimizing the values of the dot product of other encoded image-text pairs.

The image encoder 208 receives input images from image set 204 to be classified. The input images are encoded to create points in an encoded image space 214. That is, the encodings are k-dimensional points that form encoded image vectors, or more generally encoded media vectors when other types of media are used.

Prompts 202 are received by text encoder 206 and encoded into points of an encoded prompt space 210. Prompts 202 contain a classification of an image and may contain additional text. For example, a prompt may be “jellyfish” and the classifier may also be “jellyfish.” In another example, the classifier is still “jellyfish”, but the prompt is “a large jellyfish,” “a purple jellyfish,” “a large purple jellyfish in water,” etc. Thus, a prompt 202 may be text that includes the classifier, the classifier assigned to an image in image set 204. Further, the encoded prompt space 210 can include an encoding of all possible prompts 202. It has been shown that noticeable performance improvements can result from prompt engineering (e.g., using one prompt over another to improve image classification). However, determining what makes a prompt a good prompt and which prompt is the best from a set of prompts is needed.

The encoding (embedding) of an image in the encoded image space 214 can be compared against the encodings (embeddings) in the encoded prompt space 210 that correspond to respective prompts 202. The comparison between the image encoding and each of the text/prompt encodings can be done using the dot product. Using the dot product, the highest value will correspond to the closes matching prompt. In another example, the comparison can include considering the difference between the image encoding and text encoding. Using the difference, the smallest difference is the closes text encoding which corresponds to the closest matching prompt. The closest matching prompt can include the predicted image class label (i.e., the classification).

Embodiments of the present disclosure allow for the best prompt from the encoded prompt space 210 to be identified. Classification model 212, which can be a fully connected layer, can be trained using an optimization algorithm such as stochastic gradient descent (SGD). Image encodings can be provided as the classification model's 212 input. Using the corresponding correct image labels as the output the classification model 212 can be trained to find the best encoded prompt in encoded prompt space 210. Classification model 212 can be a trained neural network (NN) layer, which may comprise a k×m matrix, where k is dimensionality of the space and m is the number of possible class labels. Each column of the matrix corresponds to one of the m class labels. By training classification model 212 (e.g., using stochastic gradient descent (SGD)), the best prompt (associated with a column of the matrix) for each class of images (associated with a row of the matrix) can be found by minimizing the difference between the image encodings to their best corresponding encoded prompt. The resulting one-hot m-dimensional vector can represent the true class label. Therefore, an encoded image represented within the encoded image space 214 may be identified as corresponding to an encoded prompt in the encoded prompt space 210.

Additionally, classification model 212 may be a neural network with one or more layers. Classification model 212 can be used to determine a prompt encoding given the input image encoding/embedding. As other examples, classification model 212 can be linear regression models, logistic regression models, support vector machine models, decisions tree models, k-Nearest Neighbor models, naïve bayes models, random forest models, etc.

Since the identified best prompt (associated with a column of the matrix) is a high-dimensional vector format, text decoder 216 can receive the high dimensional encoded prompt from encoded prompt space 210 to decode the encoded prompt, thereby generating decoded prompts 218.

As described in greater detail below, text decoder 216 is paired with text encoder 206, which may be a pretrained CLIP text encoder. Text decoder 216 can be trained in an unsupervised fashion with a large number of prompts 202. Output generated by the text decoder 216 can summarize the visual contents of the image data 220. Further, the output generated by the text decoder 216 can reveal feature co-occurrence that may potentially bias the learning of correct image features. In an embodiment, the text decoder 216 is a fine-tuned large language model (LLM) (e.g., DistilGPT from Hugging Face). To fine tune the model, a large text dataset may be used (e.g., COCO2014 annotation dataset). For example, using the text encoder 206, each of the sentences in the large text dataset may be encoded as a kD embedding (encoding). The embeddings of all sentences may be the input of the large language model and the output of the large language model may be the corresponding sentences (i.e., sentence reconstruction), i.e., decoded prompts 218. The large language model may be fine-tuned for a number of epochs (e.g., ten epochs) and have its reconstruction power evaluated with a validation set of the large text dataset. A bilingual evaluation understudy (BLEU) score of 0.590 may be sufficient for a trained text decoder in some embodiments.

Thus, embodiments of the present disclosure are capable of allowing the best prompt to be learned, identified, and visualized among other prompts. A visualization of prompts in encoded prompt space 210 may help a user intuitively explore how prompts are related to other prompts, classifications, images, etc. Further, the intuitive exploration of the prompt space can help explain how a machine learning model functions. Additionally, each prompt in encoded prompt space 210 is capable of being decoded by text decoder 216 so that the best prompt and/or any other prompt can be decoded and textualized, which may disclose essential features of the image datasets and lead to better understanding of the data within the dataset(s).

### B. Example Architecture of Classification Model

Classification model 212 can be based on various kinds of architectures. Below are examples of different architectures for the classification model.

1. Mapping from Encoded Media Space to Encoded Prompt Space.

In some embodiments of the present disclosure the architecture of the machine learning model may include a mapping between encoding spaces. The mapping may be done by a mapping model, which can transform input encoded data into a different encoding space where classification becomes more feasible.

In an encoding mapping architecture, an encoder can receive input data such as images, texts, video, or any other high-dimensional data. The encoder(s) can transform(s) the input data into an encoded media space, such as encoded image space 214. This may be done using techniques such as Principal Component Analysis (PCA), autoencoders, and t-Distributed Stochastic Neighbor Embeddings (t-SNE), among others. The encoding space can retain the important features of the input data for classification.

A mapping model (e.g., as part of a classifier) can then be applied to transform an encoded media vector into the encoded prompt space, resulting in a mapped vector. The mapped vector can be compared to the encodings of the prompts from the media-prompt pairs. If the mapping model is accurate, the mapped vector should equal or be closes to the encoded prompt vector of the correct classification. However, the mapped vector P may or may not be close to an encoded prompt vector generated using a prompt with the correct classification of the media item.

During training, the closest encoded prompt vector of the training set of media-prompt pairs can be selected and a predicted classification determined. If the classification is incorrect, then the mapping model can be updated so that a better mapped vector is generated, namely one that is closer to the correct classification. This training can be performed over all the media items and different types of prompts, e.g. the additional text in addition to the classification in the prompt. In this manner, the mapping model can be trained to generate the best encoded prompt vector corresponding to the correct classification.

Thus, the mapping model (e.g., a neural network layer) can be optimized to identify the best prompts corresponding to the correct classifications across the training set. Then, the mapping model can be used in combination with some distance metric (e.g., as defined via a clustering model) to select the closest encoded prompt vector, whose classification is known. In other implementations, the mapped vector can be input to a decoder, which can output the classification.

### 2. Neural Network

In some embodiments of the present disclosure, the architecture of the machine learning model (classification model) may be a neural network that outputs a probability of a particular encoded media vector as corresponding to each of the set of classifications. A neural network-based architecture may be a feedforward neural network (FFNN). The input data can be media such as images, text, or video to which an encoder generates the encoded media vector. The network can include several layers: input layer, hidden layers, and output layer.

The network learns by adjusting the weights of the connection through backpropagation, minimizing a loss function using an optimization algorithm such as SGD.

### 3. Probabilistic Classification

In some embodiments of the present disclosure, the architecture of the machine learning model may consist of a SoftMax classifier with a neural network architecture. The SoftMax Classifier is a type of neural network that is specifically designed for multi-class classification problems. It provides a set of probabilities that a given input belongs to each of several different classes. The class with the highest probability is typically selected as the prediction. This architecture type can be used for classification tasks where the output needs to be identified the input as belonging to one of several possible classes. Much like other architecture types described above, this architecture consists of layers with the SoftMax function being applied at the final layer.

A person or ordinary skill in the art would understand that the architectures described below are merely examples and should not be interpreted as limiting.

### III. Use of Media Embeddings by Classification Model

Elements of the trained language-media model them be used to train a neural network model. The neural network model may be a classification model, such as classification model 212 in FIG. 2, that utilizes the trained image encoder and text encoder to train the neural network model to determine a classification of a media item. Further described herein are systems and methods for training a machine learning model using the media embeddings of the trained language-image model to classify media.

### A. Training ML Model to Use Media Embeddings

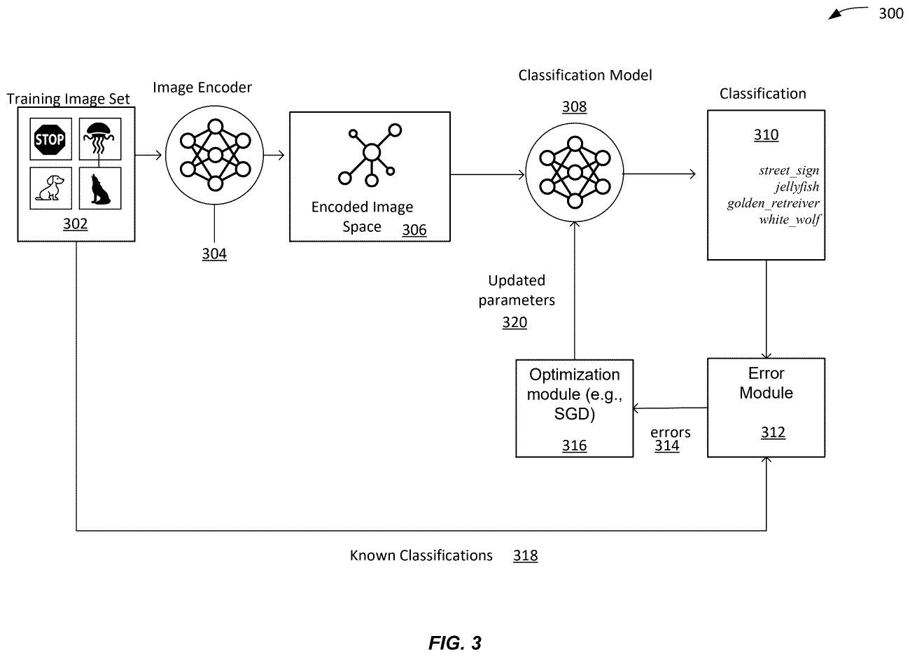

FIG. 3 illustrates a system 300 for training a classification model according to some embodiments. System 300 involves training classification model 308 using media embeddings. Classification model 308 is trained to receive media embeddings and output a classification 310 for the media.

In broad terms, the process of training a machine learning model can involve determining the set of parameters that achieve the “best” performance, often based on the output of a loss or error function. A loss function typically relates the expected or ideal performance of a machine learning model to its actual performance. For example, if there is a training data set comprising input data paired with corresponding labels (indicating, e.g., whether that input data corresponds to normal data or anomalous data), then a loss function or error function can relate or compare the classifications or labels produced by the machine learning model to the known labels corresponding to the training data set. If the machine learning model produces labels that are identical to the labels associated with the training data, then the loss function may take on a small value (e.g., zero), while if the machine learning model produces labels that are totally inconsistent with the labels corresponding to the training data set, then the loss function may take on a larger value (e.g., one, a value greater than one, infinity, etc.).

In some cases, the training process can involve iteratively updating the model parameters during training rounds, batches, epochs, or other suitable divisions of the training process. In each round, a computer system can evaluate the current performance of the model for a particular set of parameters using the loss or error function. Then, the computer system can use metrics such as the gradient and techniques such as stochastic gradient descent to update the model parameters based on the loss or error function. In summary terms, the computer system can predict which change to the model parameters result in the fastest decrease in the loss function, then change the model parameters based on that prediction. This process can be repeated in subsequent training rounds, epochs, etc. The computer system can perform this iterative process until training is complete. In some cases, the training process involve a set number of training rounds or epochs. In other cases, training can proceed until the model “converges,” i.e., the model shows little to no further improvement in successive training rounds, or that the difference in the output of the error or loss function between successive training rounds approaches zero.

As show in FIG. 3, classification model 308 is trained from training image set 302. An image from training image set 302 is input into image encoder 304. Image encoder 304 may be an example of image encoder 208 of FIG. 2. Image encoder 304 encodes the image into encoded image space 306. Classification model receives the encoded images from encoded image space 306. Classification model 308 then outputs the classification 310 for the image. The classification 310 may be one from a list of possible classifications.

As discussed above, during the pretraining of a language-media model, a large number of prompts may be proposed to a text encoder, the text encoder encodes the prompts into an encoded prompt space. Once the language-media model has been trained, classification model 308 can utilize image encoder 304 and the embeddings in the encoded prompt space from the pretrained language-media model. A training image set 302 with known classifications 318 can be input into image encoder 304. The image encoder embeds the training image set 302 into the embedded image space 306. Classification model can receive an encoded image from the encoded image space 306 and output classification 310 which is a classification of the image.

Error module 312 can determine errors of classification model 308. One way that errors are determined is comparing known classification 318 to classification 310 which was determined by classification model 308. Error module 312 can send errors 314 to optimization model 316. Errors 314 can include errors such as bias error, variance error, etc. Optimization module 316 can then optimize the parameters of classification model 308 by adjusting the parameters of classification model 308 iteratively to minimize a loss function. The updated parameters 320 from optimization module 316 can be used to updated classification model 308. The loss function measures the discrepancy between classification model's 308 prediction and the actual true values, i.e., known classification 318. The goal of optimization module 316 is to find the best set of parameters for classification model 308 that leads to the lowest possible loss when classifying media, thus improving the model's performance.

### B. Learning The Best Prompt

Turning back to FIG. 3, finding the best prompt for an image dataset can be equivalent to finding a point in the encoded prompt space, through which the embeddings of images are closer to their true labels' embedding. To illustrate, each point in the encoded image space 306 represents a single image in vector format, which can be represented as a k-dimensional vector representation of an image. For example, if you have an image and it's known classification 318, e.g., dog, the image in vector representation is the X_{emb} or the x-value. The known classification 318 can be represented as the y-value. The model can then learn a mapping that can apply x and y. In an example, an image of a dog is input into the image encoder 304 and the encoded image space 306. A goal can be for classification model 308 to find the corresponding prompt vector that can be applied to the image embedding and result in a corresponding vector for the dog class.

Classification model 308 can include a fully connected layer. In an example, a linear layer is created, and the linear weights will be of size k by m, where k is the size of the vector space and m is the number of classes. These parameters are used to train the model. The classification model 308 can map X_{emb} (output of image encoder 304) to a point P, in the encoded prompt space. Since X_{emb} is the output of image encoder 304, and the classification of the image is known, classification model 308 can learn what point P provides the most accurate classification.

The point P can correspond to the best prompt. The best points (prompts) P can be learned by optimizing the classification model 308. This P can reside in the space of your text embedding, such as encoded prompt space 210 in FIG. 2. In an example, classification model 308 can be trained using stochastic gradient descent (SGD) to get the best P. As part of the training, the mapped vector (P in this instance) is then walked to a point in the space where the loss is minimized. As discussed above, this may be done by updated parameters 320 of classification model 308 using optimization module 316. By training classification model 308, using SGD for example, the best model parameters are determined.

Therefore, as discussed in greater detail below, the next step in understanding the progress of classification model 308 or classification 310 for better optimization can be interpreting P. To interpret the best prompts, i.e., P vectors, each P vector may be fed into a text decoder, e.g., by splitting up into m pieces so that each piece (a kD vector) may be decoded using the text decoder. The text decoder may be paired with a language-media model text encoder to decode the P prompts into text. The decoded prompt can effectively summarize the visual contexts of the image, revealing feature co-occurrence that may potentially bias the learning of correct image features. For example, in FIG. 2, the dog image often comes with grass background. This insight helps to better understand the data.

### C. Use of Trained Classification Model

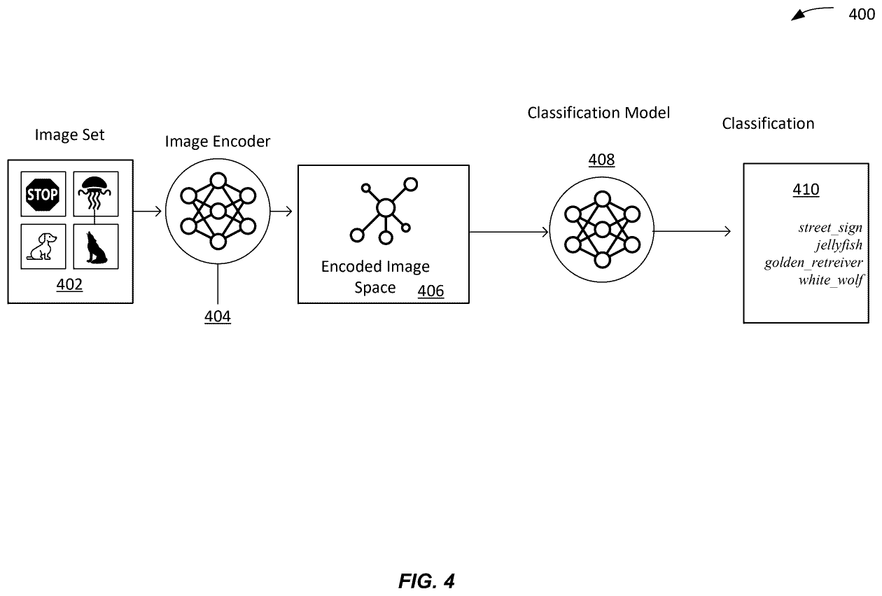

FIG. 4 illustrates a system 400 for determining the classification of according to some embodiments. System 400 uses a trained classification model 408 to classify media.

An image from image set 402 may be inserted into image encoder 404. Image encoder 404 may be a pretrained image encoder from a language-media model such as CLIP. Image encoder 404 can encode the image into an encoded image space 406. Classification model 408 receives an encoded image from encoded image space 406 and determines classification 410 for the encoded image.

As discussed above, classification model 408 can be various different kinds of models and may be trained using different optimization algorithms. In an example, classification model 408 can be trained using SGD. In another example, classification model 408 can be a probabilistic classifier that predicts the probability that an input instance belongs to each possible class. A person or ordinary skill in the art would interpret classification model 408 as different possible machine learning models trained in various ways.

In some embodiments, the encoding (embedding) of an image in the encoded image space 406 can be compared against the encodings (embeddings) in an encoded prompt space that corresponds to respective prompts. The comparison between the image encoding 408 and each of the text/prompt encodings is done using the dot product. The greatest dot product value may be the text encoding corresponding to the classification 410 and therefore may be the predicted image classification.

In an example, the index of the dot product (argmax) can be interpreted to determine the predicted classification using the following equation: argmax (softmax (I_{emb}*T_{emb}), where T_{emb} includes the embeddings of all text labels (e.g., m text labels). Thus, T_{emb} would be sized m by k.

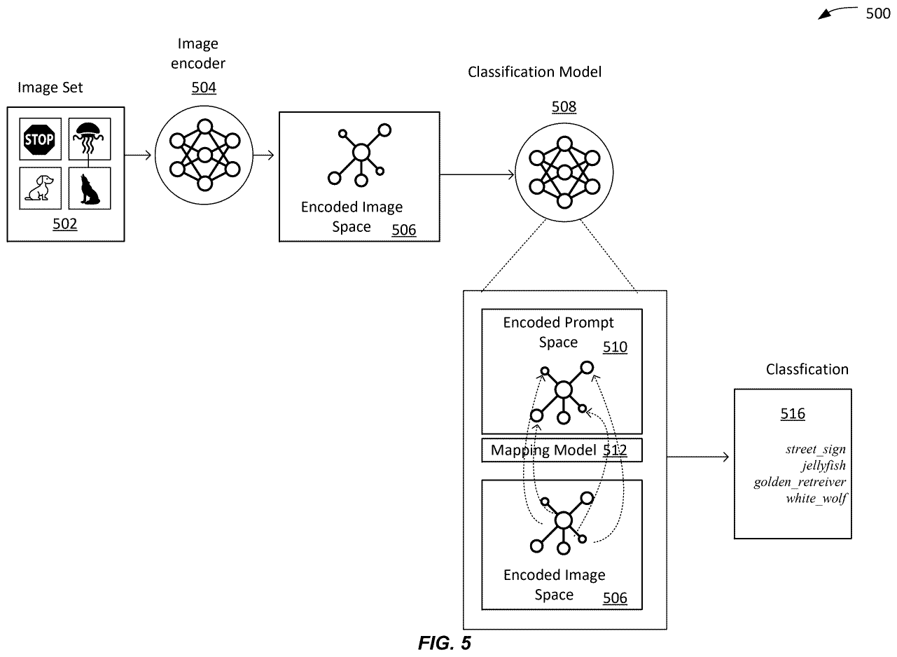

FIG. 5 illustrates a system 500 for determining the classification of according to some embodiments. System 500 uses a trained classification model 508 to classify media. System 500 is an example of system 400 in FIG. 4 where classification model 508 includes a mapping model 512. An image from image set 502 can be encoded by image encoder 504. The encoded image can be embedded into encoded image space 506. Classification model 508 can retrieve the encoded image from encoded image space 506 and output classification 516, the classification of the image.

Embodiments of the present disclosure can identify the best prompt with a correct classification from the encoded prompt space 510. Classification model 508 may include mapping model 512. Using image encodings as inputs for classification model 508 and the corresponding known image classification as the output, mapping model 512 can generate a mapped vector that is used to find the best encoded prompt in an encoded prompt space 510 that was generated from a prompt including the correct classification. Thus, the mapping model 512 can map from the encoded image space 506 to a mapped vector in encoded prompt space 510 where a classification can be determined.

Accordingly, mapping model 512 can generate a mapped vector from an encoded image vector. The mapped vector can then be compared against the encoded prompt vectors of the training set. As described in below, an example implementation may be using SGD where the closest encoded prompt vector may identify a corresponding prompt in the encoded prompt space.

In some embodiments, classification model 508 can be a trained neural network (NN) layer comprising a k×m matrix, such as mapping model 512, where k is the dimensionality of the space and m is number of possible classes. Each column of the matrix corresponds to one of the m class labels. By training classification model 508 (e.g., using stochastic gradient descent (SGD)), the best prompt (associated with a column of the matrix) for each class of images from image set 502 (associated with a row of the matrix) can be found by minimizing the difference between the image encodings to their best corresponding encoded prompt in the encoded prompt space 510. Therefore, an encoded image represented within encoded image space 506 may be identified as corresponding to an encoded prompt in the encoded prompt space 510. Classification model 508 can then output the encoded prompt from encoded prompt space 510. The encoded prompt can include classification 516 of the image from image set 502.

In some embodiments, determining classification 516 can include retrieving one or more reference encoded prompt vectors each corresponding to a known classification. A mapped vector can be determined by mapping from the encoded media item, such as encoded image from encoded image space 506, to the known, such as classification 516. The mapped vector can be compared to the reference encoded prompt vectors to identify a closest reference encoded prompt vector. Accordingly, the classification can be determined based on the closest reference encoded prompt vector. In some embodiments, classification 516 can be extracted from the encoded prompt.

To find the best prompt using SGD, the encoders (e.g., encoders of CLIP) transform the images and prompts into respective kD spaces. For each image, the kD representation, Iᵢ, and its corresponding correct label are known.

Where m is equal to the number of classes, an mkD vector, P, in the encoded prompt space can be found by training classification model 508, a fully-connected layer, with m pieces of kD vectors such that the dot product between Iᵢ and the kD vector of the correct class is larger than the rest of the m−1 vectors.

Classification model 508 may be trained with an input of kD image embeddings (encodings in the encoded image space 506) and an output of mD image labels, where the weight is P∈R^{k}^{ₘ} and the bias is disabled. By training classification model 508 through SGD, the best parameter (a prompt) may be determined that can include classification 516. The following code shows a simple PyTorch implementation of such a model, which is name PromptSearch.
class PromptSearch (nn.Module):

```
def _{——}init_{——}(self):
  super(PromptSearch, self)._{——}init_{——}( )
  self.fc = nn.Linear (k, m, bias = False)
def forward(self, x):
x = self.fc(x)
logits = 100. * x
return logits
```

### D. Method for Using Encoded Media to Classify Media Item

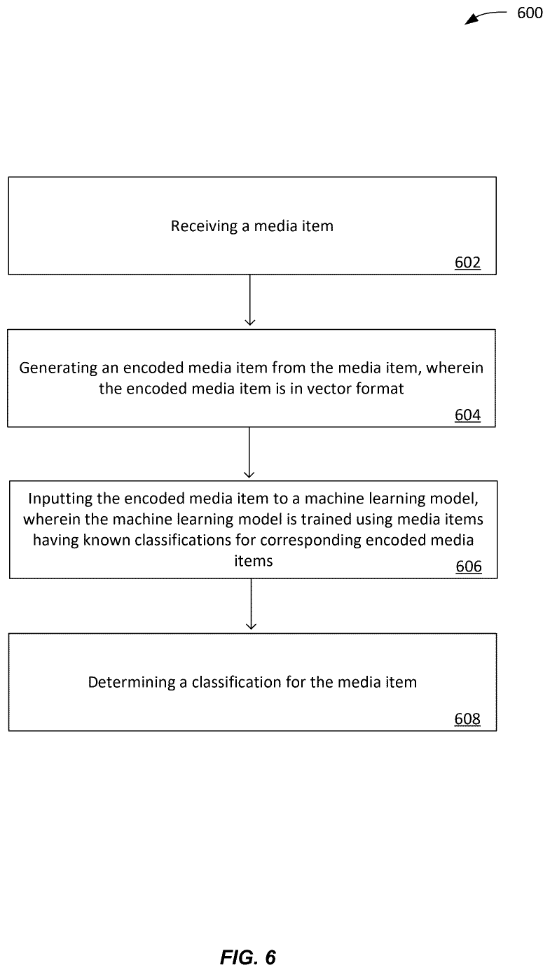

FIG. 6 illustrates a method 600 of using a trained language-image machine learning model according to some embodiments. Method 600 can be performed by one or more processors of a computer.

Method 600 begins at operation 602 with receiving a media item. Example implementations of the systems and methods described herein use the example of an image classifier; however, it can be imagined that the same systems and methods can be used to classify various media such as video and audio media items.

The received media item from operation 602 can be input into a media encoder. The media encoder may be a pretrained language-media model where the media encoder is a transformer. At operation 604, an encoded media item is generated from the received media item at operation 602. The media item may be encoded using the media encoder. The ended media item can be in a vector format.

At operation 606, the encoded media item is input into a machine learning model, wherein the machine learning model is trained using media items having known classifications for corresponding encoded media items. The machine learning model may be trained using stochastic gradient descent (SGD).

At operation 608, a classification for the media item is determined. The machine learning model can generate an encoded prompt output, the encoded prompt output in vector format. The encoded prompt output including the classification of the media item. Using a text decoder, a prompt may be generated using the encoded prompt output. The prompt may be in text format and may describe featured of the media item in addition to the classification of the media item.

### IV. Detecting Biases

Each prompt can reveal data bias of the machine learning model. For example, a prompt may disclose feature co-occurrences. For an example of a co-occurrence, a model may often mistake dog that is in snow for a wolf because the model was trained on pictures of wolves that appear in snow and thus associated snow within a picture for meaning that a wolf is also in the picture. A decoded prompt may reveal the features being focused on such as if the decoded prompt read “One gray and white dog standing in the snow.” Such a prompt may allow a better understanding of undesired feature co-occurrence in a model and/or dataset.

However, the machine learning model outputs the encoded prompts which are in vector format, and thus hard for humans to read. Therefore, a text decoder may be used to decode the encoded prompt into text format to assist in bias detection.

### A. Text Decoder

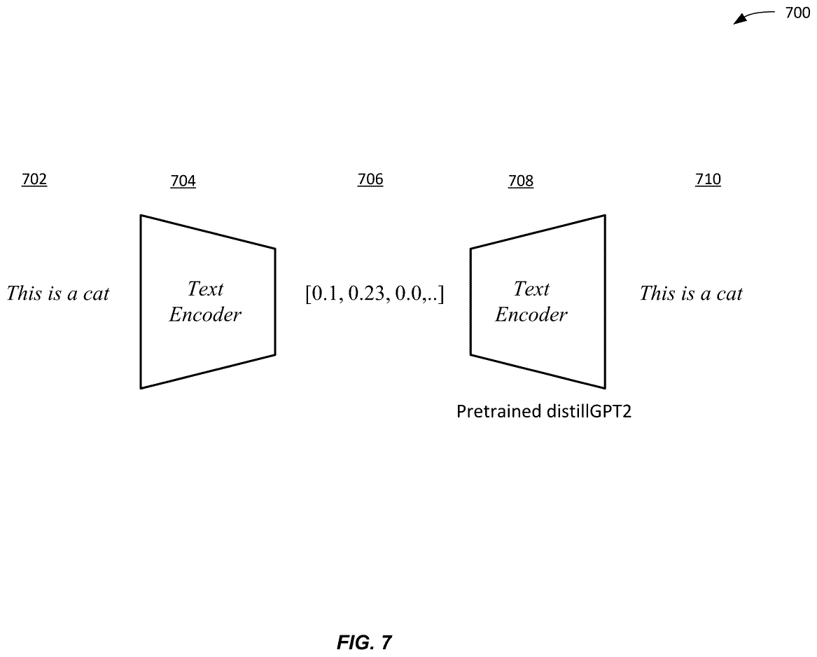

FIG. 7 illustrates system 700 for prompt decoding according to some embodiments. The best prompt identified is an HD vector which is hard for humans to interpret. In some embodiments, text decoder 708 is trained to decode encoded prompt 706 back into the text space to output a decoded prompt 71-. Text decoder 708 may be paired with text encoder 704 and trained in an unsupervised fashion using a large number of possible sentences, i.e., prompts. The decoded prompt can effectively summarize the visual contents of the image data, revealing feature co-occurrence that may potentially bias the learning of correct image features.

Each prompt is a sentence 702 that can be encoded by text encoder 704 in an encoded prompt space. Each prompt is a point in the encoded prompt space and is in vector format. When a classification model determines a prompt that corresponds to a classification of an image, it is it essentially finding the closest point in the encoded prompt space. Therefore, when a classification model determines the best prompt, it may be an encoded prompt, such as encoded prompt 706, that is in vector format.

To interpret encoded prompt 706, which is in vector format, each vector may be split up into m pieces so that each piece (a kD vector) may be decoded using text decoder 708. Text decoder 708 may paired with text encoder 704 to decode encoded prompt 706 into text. The text is decoded prompt 710.

Text decoder 708 can be trained by using a large text database. Within this database, each instance can be one sentence 702, such as “this is a cat.” Sentence 702 is input into the language-image model text encoder 704. Text encoder 704 outputs encoded prompt 706 which is a vector representing the sentence. Text decoder 708 would then learn what encoded prompt 706 represents in text format. Since this is a reconstruction, the correct output is known and therefore, this may be accomplished via unsupervised training. Knowing the input to the text decoder 708 (i.e., the output of the text encoder 704) and the correct output for the text decoder 708 (i.e., the input of the text encoder 704), text decoder 708 can be trained.

Using cat, for example, the input to the text encoder 704 is known: “this is a cat.” The output of the text encoder 704 is also known, encoded prompt 706. Therefore, the text decoder 708 may be trained by receiving as an input encoded prompt 706 and then fine-tuned with the knowledge of what the output should be “this is a cat,” sentence 702. The decoded prompt can effectively summarize the visual contexts of the image, revealing feature co-occurrence that may potentially bias the learning of correct image features.

Text decoder 708 can be used to understand the prompt landscape. As described in greater detail below, as the classification model is trained, it outputs encoded prompts that can be plugged into a scatter plot, i.e., the prompt landscape. To better understand the prompt landscape, different points on the plot, each representing an encoded prompt, can be decoded using text decoder 708. For example, a point α in the prompt landscape is input into text decoder 708. Text decoder 708 interprets the point and outputs decoded prompt 710 corresponding to that point. Next, point β can be decoded to reveal decoded prompt 710 corresponding to that point. Then point γ, which can be the optimal prompt point, can also be decoded back to reveal decoded prompt 710 corresponding to that point, and so on. By having a text output for the different points in the prompt landscape, the different prompts can be interpreted by humans. Text decoder 708 is useful for understanding what the best prompts are, how to optimize the classification model, and detect biases in the prompt output.

Instead, a training a text decoder from scratch, a pre-trained large language model (LLM) may be fine-tuned. For example, a pre-trained DistilGPT2 from Hugging Face may be used. To fine-tune the model, a large text dataset is used, such as, for example, the COCO2014 annotation dataset which has captions for 82,783 training images. The large text dataset can have captions for a large number of training images. Each image can have at least five captions, while some may have even more. In total there are a total of sentences equal to the number of captions times the number of training images. For example, if there are 82,783 training images and each have at least five captions, in total there are 414,113 sentences. Using a language-image model text encoder, each of the sentences may be encoded as a kD embedding. The embeddings of all of the sentences are inputs of the LLM, e.g., DistilGPT2, and its outputs are the corresponding sentences, i.e., sentence reconstruction. The LLM can be fine-tuned for ten epochs and the reconstruction power is evaluated on the validation set of the large text dataset. For example, using COCO2014, the fine-tuned LLM trained for ten epochs can have a validation set of 202,645 validation sentences. The fine-tuned DistilGPT2 achieves a BLEU score of 0.590, which is good.

### B. Determining Prompt and Bias

Outputs generated by the text decoder can summarize the visual context of an image. Further, the output generated by the text decoder can reveal data bias such as feature co-occurrence.

As illustrated in FIG. 2, decoded prompts 213 can describe features of image data 220. Decoded prompts 218 may illuminate how some sentences describe things similar to the correct class but may not use the class name. For example, automobile and cat classes can be described as car and kitty, respectively. In another example, some descriptions do not have the correct object in the sentence but contain something visually similar, e.g., airplane vs. kite in the sky, deer vs. calves.

In another example, once decoded, a prompt may read “This is an image of a very nice-looking kit with a keyboard, bayonet, and umbrella.” In the early stages of training, on the other hand, the prompt may read “This is a very nice looking Kitxico style car with a background.” This reveals that during the early stages of training, the classification model had not yet narrowed in on the correct class, in this case, car.

In the example of feature co-occurrences, a model may often mistake dog that is in snow for a wolf because the model has been trained on pictures of wolves that appear in snow and thus associated snow within a picture for meaning that a wolf is also in the picture. A decoded prompt may reveal the features being focused on such as if the decoded prompt read “One gray and white dog standing in the snow.” Such a prompt may allow a better understanding of undesired feature co-occurrence in a model and/or dataset.

### C. Method for Determining Text Describing Media Item.

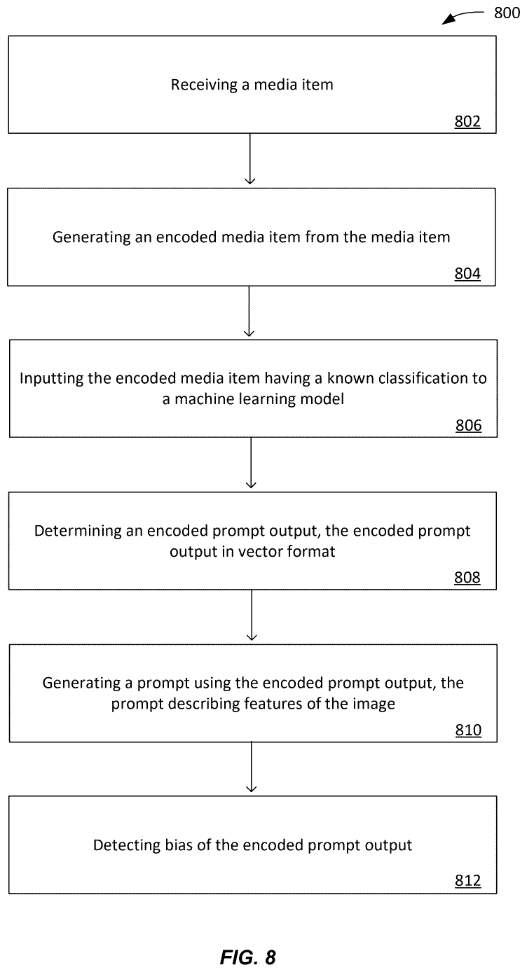

FIG. 8 illustrates method 800 for determining the best prompt and then decoding the prompt according to some embodiment of the present disclosure. Method 800 can be performed by one or more processors of a computer.

At operation 802 a media item is received. The image may be received by a media encoder of a media-language model. At operation 804 an encoded media item is generated from the media item. The media encoder may generate the encoded media item. Each media item is encoded in a k-dimensional (kD) space. The media encoder may extract relevant features from the media item and represent them as vectors in a high dimensional space.

At operation 806, the encoded media items having a known classification are input into a machine learning model. The machine learning model can be a classification model.

At operation 808, the machine learning model can determine an encoded prompt output, the encoded prompt output in vector format. The encoding of the media item can be compared against the encodings in an encoded prompt space. The comparison between the media encodings and the text encodings can be done using the dot product. The highest dot product can correspond to the known classification. In this way, the machine learning model finds the best prompt.

By training a fully connected layer using an optimization algorithm, such as SGD, using media encodings as the layer's input and the corresponding media classification as the output, the model can be trained to find the best encoded prompt in an encoded prompt space. The trained neural network (NN) layer may comprise a k×m matrix, where k is dimensionality of the space and m is the number of classes. Each column of the matrix corresponds to one of the m class labels. By training a model (e.g., using stochastic gradient descent (SGD)), the best prompt (associated with a column of the matrix) for each class of media items (associated with a row of the matrix) can be found by minimizing the difference between the media encodings to their best corresponding encoded prompt. Therefore, an encoded media item represented within the encoded image space may be identified as corresponding to an encoded prompt in the encoded prompt space.

Additionally, the model used to determine a prompt encoding, given the input media encoding/embedding may be a neural network with one or more layers. In an embodiment, the machine learning model is not a neural network (e.g., linear regression models, logistic regression models, support vector machine models, decisions tree models, k-Nearest Neighbor models, naïve bayes models, random forest models, etc.).

Since the identified best prompt (associated with a column of the matrix) is a high-dimensional vector format, a decoder can receive the high dimensional encoded prompt (e.g., prompt in the encoded prompt space) from the encoded prompt space to decode the encoded prompt, thereby generating a decoded prompt.

At operation 810, a prompt is generated from the encoded prompt output, the prompt describing features of the media item. As discussed above, a transformer decoder paired-up with a text encoder may be trained to decode and interpret the HD prompt vectors. The decoder can be trained in an unsupervised fashion with a large number of prompts. Output generated by the text decoder can summarize the visual contents of the media data.

At operation 812, the prompt can be used to detect data bias of the encoded prompt output. The output generated by the text decoder can reveal feature co-occurrence that may potentially bias the learning of correct media features. As described above, the data biases illuminated by the text decoder, such as undesired feature co-occurrence, reveals issues in the training of earlier models and allows for a visual way to evaluate prompts and continue to improve such models.

### V. Visualizing the Prompt Landscape

### A. Prompt Landscape

A loss landscape may be used to visualize the large parameter space of deep neural networks (DNNs). Assuming the trainable parameters of a DNN is composed of n scalars, an algorithm considers them as a point in the nD space and picks two directions in the space to walk the point. To the end, the point is extended to become a 2D plane with a grid structure. The value on each grid point is the DNN's loss when taking the corresponding grid point's value as the DNN's parameters. By encoding the loss value into the depth of the grid point, the 2D plane will become a 3D surface, i.e., the loss landscape. Using a loss landscape, the DNN's trainable parameters may be explored.

For example, there can be a visualization of the optimization of the NN layer (P). Each iteration of P during the training process can be used to provide representative sentences (prompts) for the corresponding classifications. Further, perturbations of the optimal NN layer (e.g., in principal component directions) can be used to explore the types of prompts that are representative around the optimal (trained) NN layer.

Current methods of visualization to understand, diagnose, and improve machine learning concentrate on iterative refinement of prompts. However, the approach described in the present disclosure employes a searched-based solution to identify the best prompt. Unlike previous methods of directly exploring prompts, as in previous works, some advantages of present the present disclosure includes transforming the prompts into a latent space for a more comprehensive overview and more intuitive exploration.

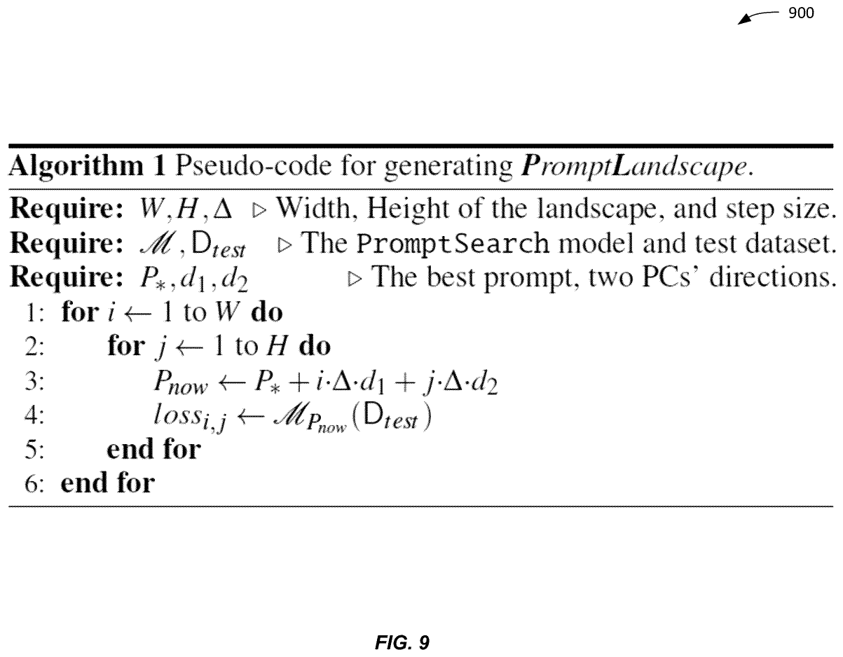

FIG. 9 illustrates pseudocode 900 for generating a prompt landscape according to some embodiments. During the training of the SGD model to find the best prompt, when the weight of the learning model is a prompt, the loss landscape may be the landscape of prompts. Therefore, the weight may be obtained at each training epoch of the model, denoted as P₁, P₂, . . . , Pₙ. All of the weights stacked together may be represented as a matrix shape n×mk. When a principal component analysis (PCA) is applied to the n×mk matrix, two principal components (PCs) of the matrix may be obtained (e.g., two orthogonal directions in the mkD space) and may be denoted as d₁ and d₂. The d₁ and d₂ lie along a line in which the n points/prompts show the maximum variance. A prompt landscape may be generated by walking the best prompt (P*) along the two principal component directions and computing the loss at each location (grid point of the prompt landscape). In an embodiment, instead of using the two principal component directions to extend the landscape surface, random directions may be used when generating the landscape.

When generating a prompt landscape, a step size may be chosen. Step size is represented as “Δ” in pseudocode 900. The step size when walking the best prompt determined the sampling density in the covered spatial domain. A small A (step size) may significantly increase the computation cost and result in small special coverage. A large A (step size) may hide the geometric details of the landscape. In an embodiment, A (step size) with a value of 0.01 is used. In an embodiment, the A (step size) is changed based on the image dataset being used.

When generating a prompt landscape, it may also be useful to normalize the best prompt when walking it in the space to generate the prompt landscape. In some embodiment, the encodings used to train the text decoder may be normalized to help obtain reasonable decoding results.

As an example, when a prompt landscape with a resolution of W×H is generated (lines 1-2 of pseudocode 900), the mkD prompt at each grid location (i,j) can be obtained (line 3 of pseudocode 900). At line 4 of pseudocode 900, the loss value of the grid point (i,j) may be obtained by setting the weight of the prompt search model (denoted as mPnow).

Upon repeating the loss computation across all of the W×H locations, the prompt landscape is obtained and can then be visualized. Such repetition steps may be seen in lines 1-2 and 5-6 of the pseudocode 900.

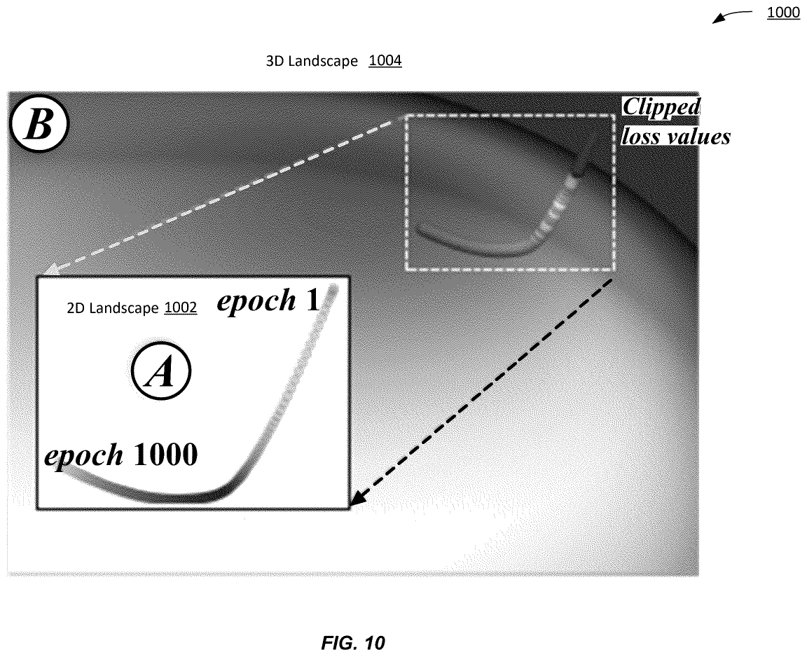

FIG. 10 illustrates a principal component analysis projection of prompts and an example of a prompt landscape where a two-dimensional space is extended, and each point is colored with the training loss. In an example, the SGD model was trained for 1000 epochs and the parameters/prompts were dumped/obtained at the end of each epoch. 2D landscape 1002 illustrates a two-dimensional principal component analysis projection of the 1000 points. The earlier epoch points are lighter, and the later epoch points are darker. 3D landscape 1004 illustrates an example of a prompt landscape where a two-dimensional space is extended, and each point is colored with the training loss. 3D landscape 1004 is an example of a prompt landscape, shown from above (facing the x-y plane), obtained by walking P₁₀₀₀ in the projected principal component analysis space along the two principal components. The x, y, and z values of the three-dimensional surface represent the first principal component, the second principal component, and the loss values of the SGD model (prompt search model), respectively. The points/prompts obtained from the 1000 training epochs may be represented on (e.g., super imposed on) the prompt landscape.

In an example, the classification model is trained for 1000 epochs. The model dumps the parameters/prompts at the end of each epoch. 2D landscape 1002 shows the 2D principal component analysis projection of the 1000 prompts. For this example, the vectors can be in a 512-dimensional format. Accordingly, there may initially be 1000 P vectors in a 512-dimensional format.

After one training iteration, you get a P value, after a second training iteration, you get another P value. After training with 1000 epochs, there may be 1000 P points. Principal component analysis (PCA) may be used to principal components on the matrix. The derived points can be plugged into a scatter plot and projected into a 2D space.

2D landscape 1002 illustrates a 2D space with 1000 epoch parameters plugged into a scatter plot. As illustrated, the first epoch parameter, epoch 1, can be projected on the far right. As the model is trained, the P point is walking into a different point in the 2D space. At some point, you reach the far left. The final point, for example, point 1000, represents the best prompt.

3D landscape 1004 illustrates the same space including a color scheme where the darker gray indicates a high loss value, and the lighter gray indicates very little or no loss. As illustrated, the earlier epoch iterations return a P value with a very high loss value. As the model is trained, the P values returned for later epoch iterations have a lower loss value.

Walking the point P is done by adding a delta (a small constant) and multiplying the first principal component direction, d₁. Where e is the epoch number and z are the principal component.

Pₑ+delta*d_{z} [Equation 1]

This equation results in another P value, P′. This point, P′, is somewhere away from the original point, P. P′ is still in a 512 dimension, so now you can plug in the 512 vector into Equation 4 below to get a new loss value. Where y is the dot product and X_{emb} is the vector form the image encoder.

X_{emb}*P=y [Equation 2]

This can be repeated. For example, by adding 2*delta, the point P can be walked a second time and so on, as shown in Equation 5 below, where a is the number if time the point is being walked.

Pₑ+(a*delta)*d_{z} [Equation 3]

In this way, the point can be walked along the space vertically.

As discussed, the point P can be walked in multiple directions. For example, P can be walked in a second principal component direction, d₂. To know the loss value, the new P′ values can be plugged back into [Equation 2].

X_{emb}*P=y [Equation 2]

Since the true y value was known originally, by plugging in X_{emb} and P you get a new y value, y′. y′ can then be compared the true y value, the known label, to determine the loss value. The loss at each grid point can be color coded to show the reduction in loss value as optimization is reached.

To create a landscape, you encode the loss into the depth of the geometry. For example, in a 3D space, encoding the depth into the color. In this way, one can visualize the optimization. For example, during training the loss value may be very high at first and at each iteration, the loss remains high. As the model continues to be trained, the loss gets lower, meaning the model is closer to optimization.

Turning back to FIG. 10. The x, y, and z axis of this 3D surface represents the 1^{st} PC, the 2^{nd} PC, and the loss values of the SGD model (prompt search model), respectively.

As discussed earlier, the prompt is simply a vector which is not very interpretable for humans. The goal is to be able to not only determine the best prompt, P, in vector format, but also to understand what the encoding represents. In other to do that a text decoder can be trained.

The text decoder can take the prompt vector as input and decodes the prompt into text. The dimensionality of the inputted vector can be the dimensionality of the prompts in the encoded prompt space (e.g., 512 dimensionality times the number of possible classes). The text decoder may break down the vector by the number of possible classes. So, for example, if the vector was 512*10 possible classes, the text decoder can break down the vector into ten vectors, each of 512 dimensionality. Then each vector can be decoded and output a result for each. If there are ten possible classes, for example, the text decoder can produce ten outputs, each a portion of the prompt. The text decoder may be an existing GPT model, such as DistilGPT2.

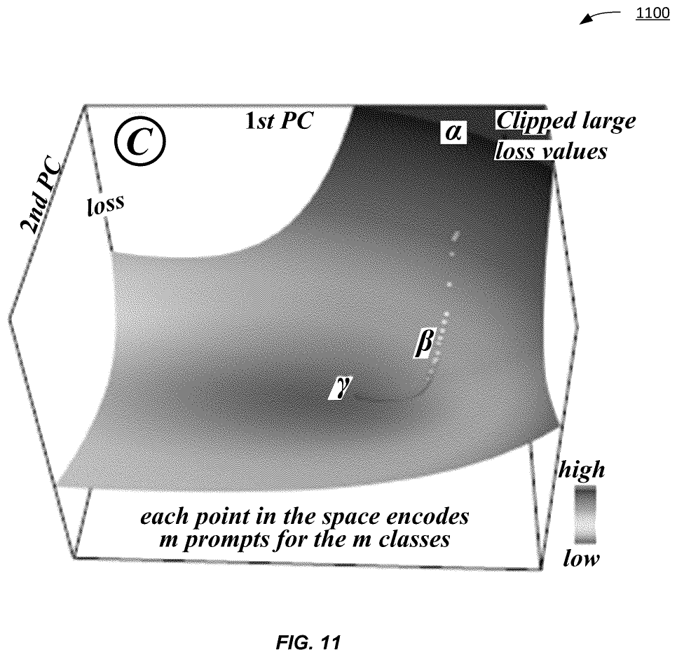

FIG. 11 illustrates a random viewing angle 1100 of the prompt landscape with the points/prompts obtained from 1000 training epochs represented in a space. Each point in the prompt landscape may encode m prompts for m class labels.

A prompt landscape, such as the one in FIGS. 10 and 11 provide an overview of the possible prompts and their quality distribution. Any point in the prompt landscape may be selected to be decoded into the corresponding prompt using a text decoder to get a sense of what the prompt represents.

In an embodiment, each point in the prompt landscape corresponds to m number of prompts (e.g., sentences), where m is the number of classes. Various observations may be made using prompts decoded from the prompt landscape.

An observation may be that some prompts may describe something that is similar to the right class. For example, an “automobile” class may be described as a car. For example, a “cat” class may be described as a kitty.

Another observation may be that some descriptions do not have the correct object but contain something visually similar (e.g., “airplane” versus “kite in the sky”, “deer” versus “calves”).

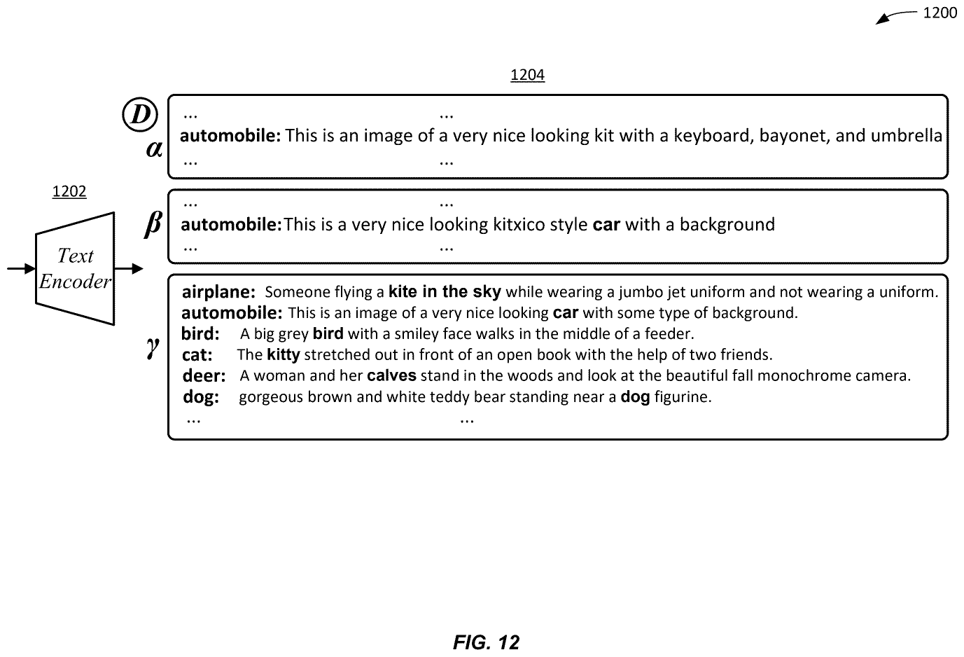

Another observation may be that by tracking the prompt landscape back to early training epochs/iterations (e.g., high locations of the prompt landscape), the performance evaluation can also be visualized. For example, in FIG. 11, point β shows the prompt from epoch 100 and point α shows the prompt from epoch 10. Once decoded, the prompt in epoch 10 may read: “This is an image of a very nice-looking kit with a keyboard, bayonet, and umbrella,” whereas the decoded prompt from epoch 100 may read “This is a very nice looking Kitxico style car with a background.” Thus, early epochs may reveal that they had not yet narrowed in on a correct class, in this case, the class was “automobile”. The point β and point α prompt is shown in FIG. 12. Further, all the best prompts y for each class after 1000 epochs are also shown in both FIG. 11 (the prompt landscape) and 12 (the decoded prompts at the best prompt point).

In some embodiments, the prompt encodings are not perfectly aligned with the image encodings in the high dimensional space. For example, the best mkD prompt vector may have its portion for the right class closer to the image's encoding than the rest of the m−1 kD portions. However, the correct kD portion of the prompt may still be far from the image's kD encoding. Thus, it can be explained why “kite in the sky” is good enough to describe an “airplane” class, as it may be relatively closer to the airplane class than the other classes (e.g., such as the “cat” class).

Additionally, certain tokens/words may not be used, or are rarely used, in the training and fine-tuning of a text decoder, e.g., automobile. However, the decoder can understand the concept of automobile and decodes it as a car, the more commonly used word. One way to improve such discrepancies is to use additional sentences while fine-tuning the decoder.

### B. Interpretation

FIG. 12 illustrates an example of decoded prompts 1200 obtained from decoding a prompt from the prompt landscape. As discussed above, the point is represented as a mkD prompt vector that is hard for human to interpret. Text decoder 1202 can take the prompt vector as input and decodes the prompt into text. As illustrated, the first point that can be interpreted is the prompt corresponding to point γ in FIG. 11, i.e., the best prompt. In FIG. 12, text decoder 1202 may receive the vector of point γ as input. Corresponding decoded texts 1204 can be output from text decoder 1202. Each point on the prompt landscape (e.g., the 3D landscape illustrated in FIG. 11) corresponds to m (e.g., m=10) sentences, one for each class. In an example, there are ten classes and therefore ten sentences.

The resulting decoded text may further allow for the exploration of prompts. This exploration may include observing how some sentences describe things similar to the correct class but may not use the class name. For example, automobile and cat classes can be described as car and kitty, respectively. In another example, some descriptions do not have the correct object in the sentence but contain something visually similar, e.g., airplane vs. kite in the sky, deer vs. calves. Additional exploring can include backtracking. By tracing the prompt back to some early training iterations (i.e., higher locations in the prompt landscape), the performance evolution of the model can be observed. For example, points β and a from FIG. 10 show the prompt from epochs 100 and 10, respectively. Their decoded texts 1204 (for automobile only) is illustrated in FIG. 12. It can be understood from the text output that at earlier prompt points, the model had not captured the car/automobile object yet.

Further, the prompt decoder may be capable of disclosing feature co-occurrences without looking through all the images in a given data set. For an example of a co-occurrence, a model may often mistake dog that is in snow for a wolf because the model has been trained on pictures of wolves that appear in snow and thus associated snow within a picture for meaning that a wolf is also in the picture. A decoded prompt may reveal the features being focused on such as if the decoded prompt read “One gray and white dog standing in the snow.” Such a prompt may allow a better understanding of undesired feature co-occurrence in a model and/or dataset.

In another example, an image of a husky can be misclassified as a wolf because of additional features of the image such as snow. The classification model may closely associate a wolf with snow and therefore the results of the classification may be incorrect. Thus, it is helpful to consider these possible feature co-occurrences in the training data.

In some embodiments, the data biases illuminated by the text decoder, such as undesired feature co-occurrence, reveals issues in the training of earlier models and allows for a visual way to evaluate prompts and continue to improve such models.

Although image encodings and prompt encodings were discussed in detail above, it is also possible to use the above-described systems and methods to perform contrast learning with various data parings. For example, a data pairing may be an image-text pair, an audio-text pair, a video-text pair, time series data pairing, etc.

### VI. Computer System

As described above, other embodiments are directed to systems, devices, and computer readable media associated with methods described herein. The systems, devices, and computer readable media can include storage media storing computer-executable instructions and can include a processor to access the storage media and execute the computer-executable instructions to perform the methods described herein.

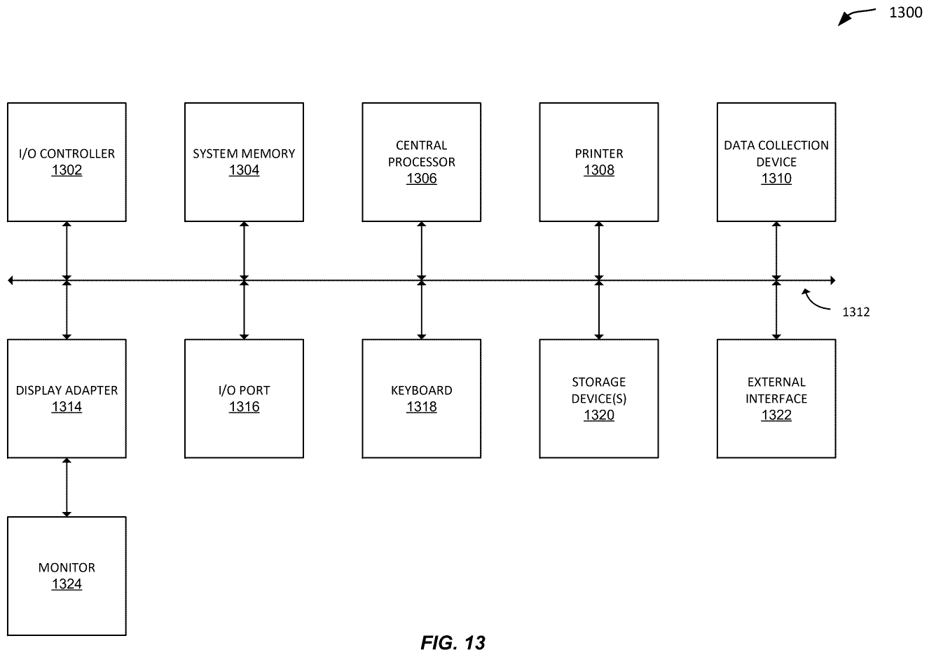

Any of the computer systems mentioned herein may utilize any suitable number of subsystems. Examples of such subsystems are shown in FIG. 13 in computer system 1300. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 13 are interconnected via a system bus 1312. Additional subsystems such as a printer 1308, keyboard 1318, storage device(s) 1320, monitor 1324 (e.g., a display screen, such as an LED), which is coupled to display adapter 1314, and others are shown. Peripherals and input/output (I/O) devices, which couple to I/O controller 1302, can be connected to the computer system by any number of means known in the art such as input/output (I/O) port 1316 (e.g., USB, FireWire®). For example, I/O port 1316 or external interface 1322 (e.g., Ethernet, Wi-Fi, etc.) can be used to connect computer system 1300 to a wide area network such as the Internet, a mouse input device, or a scanner. The interconnection via system bus 1312 allows the central processor 1306 to communicate with each subsystem and to control the execution of a plurality of instructions from system memory 1304 or the storage device(s) 1320 (e.g., a fixed disk, such as a hard drive, or optical disk), as well as the exchange of information between subsystems. The system memory 1304 and/or the storage device(s) 1320 may embody a computer readable medium. Another subsystem is a data collection device 1310, such as a camera, microphone, accelerometer, and the like. Any of the data mentioned herein can be output from one component to another component and/or can be output to a user.

A computer system can include a plurality of the same components or subsystems, e.g., connected together by external interface 1322, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components. In various embodiments, methods may involve various numbers of clients and/or servers, including at least 10, 20, 50, 100, 200, 500, 1,000, or 10,000 devices. Methods can include various numbers of communication messages between devices, including at least 100, 200, 500, 1,000, 10,000, 50,000, 100,000, 500,00, or one million communication messages. Such communications can involve at least 1 MB, 10 MB, 100 MB, 1 GB, 10 GB, or 100 GB of data.

Any of the computer systems mentioned herein may utilize any suitable number of subsystems. In some embodiments, a computer system includes a single computer apparatus, where the subsystems can be components of the computer apparatus. In other embodiments, a computer system can include multiple computer apparatuses, each being a subsystem, with internal components.

A computer system can include a plurality of the components or subsystems, e.g., connected together by external interface or by an internal interface. In some embodiments, computer systems, subsystems, or apparatuses can communicate over a network. In such instances, one computer can be considered a client and another computer a server, where each can be part of a same computer system. A client and a server can each include multiple systems, subsystems, or components.

It should be understood that any of the embodiments of the present disclosure can be implemented in the form of control logic using hardware (e.g., an application specific integrated circuit or field programmable gate array) and/or using computer software with a generally programmable processor in a modular or integrated manner. As used herein a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present disclosure may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Any operations performed with a processor may be performed in real-time. The term “real-time” may refer to computing operations or processes that are completed within a certain time constraint. The time constraint may be 1 minute, 1 hour, 1 day, or 7 days. Thus, embodiments involve computer systems configured to perform the steps of any of the methods described herein, potentially with different components performing a respective step or a respective group of steps. Although presented as numbered steps, steps of methods herein can be performed at the same time or in a different order. Additionally, portions of these steps may be used with portions of other steps from other methods. Also, all or portions of a step may be optional. Additionally, and of the steps of any of the methods can be performed with modules, circuits, or other means for performing these steps.

The specific details of particular embodiments may be combined in any suitable manner without departing from the spirit and scope of embodiments of the disclosure. However, other embodiments of the disclosure may involve specific embodiments relating to each individual aspect, or specific combinations of these individual aspects. The above description of exemplary embodiments of the disclosure has been presented for the purpose of illustration and description. It is not intended to be exhaustive or to limit the disclosure to the precise form described, and many modifications and variations are possible in light of the teaching above. The embodiments were chosen and described in order to best explain the principles of the disclosure and its practical applications to thereby enable others skilled in the art to best utilize the disclosure in various embodiments and with various modifications as are suited to the particular use contemplated.

The above description is illustrative and is not restrictive. Many variations of the disclosure will become apparent to those skilled in the art upon review of the disclosure. The scope of the disclosure should, therefore, be determined not with reference to the above description, but instead should be determined with reference to the pending claims along with their full scope or equivalents.

One or more features from any embodiment may be combined with one or more features of any other embodiment without departing from the scope of the disclosure.

A recitation of “a”, “an” or “the” is intended to mean “one or more” unless specifically indicated to the contrary. The use of “or” is intended to mean an “inclusive or,” and not an “exclusive or” unless specifically indicated to the contrary.

All patents, patent applications, publications, and descriptions mentioned above are herein incorporated by reference in their entirety for all purposes. None is admitted to be prior art.

1. A method comprising:
receiving a media item;
generating, using a media encoder of a trained language-media model, an encoded media item from the media item, wherein the encoded media item is in a vector format;
inputting the encoded media item to a machine learning model, wherein the machine learning model is trained using media items having known classifications for corresponding encoded media items; and
determining, using the machine learning model, a classification for the media item.

2. The method of claim 1, further comprising:
generating, by the machine learning model, an encoded prompt output, the encoded prompt output in vector format; and
generating, using a text decoder, a prompt using the encoded prompt output, the prompt describing features of the media item.

3. The method of claim 1, wherein the classification is extracted from the generated prompt.

4. The method of claim 1, wherein the media item is an image, an audio file, or a video.

5. The method of claim 1, wherein training the machine learning model further comprises:
receiving training media, each of the training media having a known classification of a plurality of known classifications;
processing, using the media encoder, each of the training media to obtain training media encoding vectors;
processing, using the machine learning model, the training media encoding vectors to obtain a predicted classification for each of the training media;
for each of the training media, comparing the predicted classification to the known classification; and
updating parameters of the machine learning model based on the comparison.

6. The method of claim 5, wherein training the machine learning model further comprises:
receiving a training text for each of the training media, the training text including the known classification;
processing, using a text encoder, each training text to obtain training text encoding vectors,
wherein processing, using the machine learning model, the training media encoding vectors to obtain the predicted classification comprises:
processing, using the machine learning model, the training media encoding vectors and the training text encoding vectors to determine matching text-media pairs, wherein the training text of each of the text-media pairs includes the predicted classification of a corresponding training media item.

7. The method of claim 1, wherein the machine learning model includes a neural network.

8. The method of claim 1, wherein the machine learning model provides a probability for each of the known classifications and selects the classification with a highest probability.

9. The method of claim 1, wherein determining a classification for the media item further comprises:
retrieving one or more reference encoded prompt vectors, each corresponding to a known classification;
determining a mapped vector by mapping from the encoded media item to the known classification;
comparing the mapped vector to the one or more reference encoded prompt vectors to identify a closest reference encoded prompt vector; and
determining the classification based on the closest reference encoded prompt vector.

10. A system comprising:
one or more storage media storing computer-executable instructions; and
one or more processors configured to access the one or more storage media and execute the computer-executable instructions to perform the method of claim 1.

11. A method comprising:
receiving a media item;
generating, using media encoder of a language-media model, an encoded media item from the media item, wherein the encoded media item is in a vector format within an encoded media space;
inputting the encoded media item into a machine learning model that is trained to select an encoded text vector corresponding to a correct classification of the media item;
determining, by the machine learning model, an encoded prompt output, the encoded prompt output in vector format; and
generating, using a text decoder, a prompt using the encoded prompt output, the prompt describing features of the media item.

12. The method of claim 11, wherein the media item is an image, an audio file, or a video.

13. The method of claim 11, wherein the prompt includes co-occurring features of the media item.

14. The method of claim 11, wherein training the text decoder comprises:
receiving a training prompt;
generating, using a text encoder of the language-media model, an encoded prompt from the training prompt, wherein the encoded prompt is in vector format;
processing, by the text decoder, the encoded prompt to obtain a predicted prompt;
comparing the predicted prompt to the training prompt; and
updating parameters of the text decoder based on the comparison.

15. The method of claim 11, wherein training the machine learning model further comprises:
receiving training media, each of the training media having a known classification of a plurality of known classifications;
processing, using the media encoder, each of the training media to obtain training media encoding vectors;
processing, using the machine learning model, the training media encoding vectors to obtain a predicted classification for each of the training media;
for each of the training media, comparing the predicted classification to the known classification; and
updating parameters of the machine learning model based on the comparison.

16. The method of claim 15, wherein training the machine learning model further comprises:
receiving a training text for each of the training media, the training text including the known classification;
processing, using a text encoder, each training text to obtain training text encoding vectors,
wherein processing, using the machine learning model, the training media encoding vectors to obtain the predicted classification comprises:
processing, using the machine learning model, the training media encoding vectors and the training text encoding vectors to determine matching text-media pairs, wherein the training text of each of the text-media pairs includes the predicted classification of a corresponding training media item.

17. The method of claim 11, wherein determining a classification for the media item further comprises:
retrieving one or more reference encoded prompt vectors, each corresponding to a known classification;
determining a mapped vector by mapping from the encoded media item to the known classification;
comparing the mapped vector to the one or more reference encoded prompt vectors to identify a closest reference encoded prompt vector; and
determining the classification based on the closest reference encoded prompt vector.

18. The method of claim 11, wherein the training involves determining a closest encoded text vector.

19. A system comprising:
one or more storage media storing computer-executable instructions; and
one or more processors configured to access the one or more storage media and execute the computer-executable instructions to perform the method of claim 11.
